(19) United States
(12) Patent Application Publication
(10) Pub. No.: US 2005/0052532 A1
(43) Pub. Date: Mar. 10, 2005

(54) System and method for filming and recording attractions

(76) Inventors: David Elooz, Jerusalem (IL); Ronen Segal, Jerusalem (IL); Johnathan Assia, Savion (IL)

Correspondence Address: GOTTLIEB RACKMAN & REISMAN PC, 270 MADISON AVENUE, 8TH FLOOR, NEW YORK, NY, 100160601, US

(21) Appl. No.: 10/921,695

(22) Filed: Aug. 19, 2004

Related U.S. Application Data
(60) Provisional application No. 60/500,971, filed on Sep. 8, 2003.

(51) Int. Cl. H04N 9/47; A63J 5/02

(52) U.S. Cl. 348/148

(57) ABSTRACT

A system is disclosed for providing a video record of a user's entertainment experience. The system includes a video camera system for continuous, close-up personal recording of the entertainment experience of the user and transmitting the video recording to a base unit. The system also includes a base unit for receiving, processing and distributing the video recording, such that the video record of the user's entertainment experience becomes available to the user. A method is disclosed for providing a video record of a user's entertainment experience. The method includes installing, on a vehicle provided for the entertainment experience, a video camera system comprising at least one video camera for continuous, close-up personal recording of the entertainment experience of the user. The method also includes recording a video record of the user with the video camera system during the entertainment experience and transmitting the video recording to a base unit for receiving, processing and distributing the video recording, such that the video record of the user's entertainment experience becomes available to the user.

### FIELD OF THE INVENTION

This application is based on and claims priority of provisional application No. 60/500,971, filed Sep. 8, 2003.

The present invention generally relates to recording images of attractions, and more particularly, to a system and method and for recording film and still images related to amusement parks rides and attractions, such as roller coasters.

### BACKGROUND OF THE INVENTION

The roller coaster, as an example of an entertainment attraction, came about as a way to have the excitement of Russian ice slides, traceable to at least as far back as the 1400's, available in warmer climates. In fact, in some cultures, coasters are still called “Russian Mountains.” The first wheeled versions appeared in Europe in the late 1700's, and modern renditions arrived in the mid 1880's in the United States and Canada, with many refinements after that.

The use of still pictures taken during roller coaster rides, for presentation to the riders after their ride is known in the art. Thus far video has only been used to illustrate the rides in a non-personal way.

America Screams is a landmark video hosted by Vincent Price, who apparently was a coaster fan. It is an edited video of a 48-minute television special originally shot in 1977. It highlights about a dozen coasters in The United States. America's Greatest Roller Coaster Thrills: Next Generation, 1999 is one in the coaster series from Goldhil Home Media, and is apparently the first to feature SurroundSound. Cyclone: The Ultimate Rollercoaster, as the title suggests, is a video about the famous Coney Island “Cyclone.” It has a history of the coaster and a complete show from the perspective of a front-seat-view ride.

European Coaster Thrills, 1992, features twelve roller coasters from south and central Europe. It shows front-seat and off-train views, including aerial shots. The Discovery Channel offers a virtual ride video on “some of the scariest coasters.” The video was shot in high definition with state-of-the-art anti-shakes (?) camera equipment.

The use of videos with some recorded footage of the riders at attractions is known in the art. For example, Renie in U.S. Pat. No. 5,655,053, discloses a personalized video tape preparation system, e.g. for an amusement park, which records digital signals of an individual at pre-selected locations and uses an identification processor to combine an individual video record with standard pre-shot images. Also, Sports Media Productions uses similar technology to provide custom videos for athletes participating in events such as marathons. These technologies use cameras at fixed locations, that record images of large numbers of participants, and then requires means to identify, however accurately, a particular participant for the purpose of extracting any relevant footage to be made available for him/her to purchase.

In U.S. Pat. No. 6,618,075, Amusement Ride Camera System for Shooting Pictures by Tomita, et al, a shooting means is disposed at the optimal shooting position of a moving object along a running path of the moving object, a moving object detecting sensor is disposed at the coming side of the moving object than the shooting device, a speed sensor for measuring the running speed of the moving object, and a timing control means for deciding a shooting timing of the shooting means based on the outputs of the detecting sensor and the speed sensor, are provided. The video is also shot from a stationary control location, and is involved with getting a clear image of the subject as he/she passes at great speed.

Therefore there is a need to make available to an amusement park goer, of a continuous, unambiguous, exclusively personal, full-length, close-up video recording of his/her entertainment experience, without the need for complex, expensive, cumbersome identification mechanisms.

### SUMMARY OF THE INVENTION

Accordingly, it is a principal object of the present invention to provide a system and a method for making available, to an amusement park goer, a video recording of his/her ride experiences.

It is a further object of the present invention to provide a uniquely powerful system and a method for providing a video record of an entertainment experience of an amusement park goer.

A system is disclosed for providing a video record of a user's entertainment experience. The system includes a video camera system for continuous, close-up personal recording of the entertainment experience of the user and transmitting the video recording to a base unit. The system also includes a base unit for receiving, processing and distributing the video recording, such that the video record of the user's entertainment experience becomes available to the user.

A method is disclosed for providing a video record of a user's entertainment experience. The method includes installing, on a vehicle provided for the entertainment experience, a video camera system comprising at least one video camera for continuous, close-up personal recording of the entertainment experience of the user. The method also includes recording a video record of the user with the video camera system during the entertainment experience and transmitting the video recording to a base unit for receiving, processing and distributing the video recording, such that the video record of the user's entertainment experience becomes available to the user.

Additional features and advantages of the invention will become apparent from the following drawings and description.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1a is a schematic illustration, wherein each car of a roller coaster train is provided with a wired or wireless video camera system for recording a video movie of the people during a ride, in an exemplary embodiment of the present invention (the camera may also be wired);

FIG. 1b is a schematic block diagram of the details of the wireless video camera system of FIG. 1a, according to the principles of an exemplary embodiment of the present invention; and

FIG. 2 is a schematic illustration, wherein the video movie transmitted from the wireless video camera system of FIGS. 1a and 1b, is processed in the base unit having receivers for the video and data from the cameras, and computers to process, store and record the video and data and screens to show the videos.

### DETAILED DESCRIPTION OF A PREFERRED EMBODIMENT

The core of the present invention is video cameras that are installed, for example, on each car of a train (roller coaster) or in each car of any other ride apparatus in the park. This video camera takes video movie of the people during the ride. When the ride is finished, one can buy his video movie that shows him during the ride. The video movies may also be stored in a web server where one can access this server by means of electronic computer network communication, e.g. Internet, and buy his movie later.

The video camera can be based on, but not limited to, any video camera, either analog or digital video, color or black and white, or any other technique to capture video movies. Still pictures can be taken out of the video movie and can be sold separately, in addition to the video movie, or without any relation to it.

The invention apparatus is mainly based on two elements:
Exemplary mobile wireless, video camera or cameras; and
Base Unit.

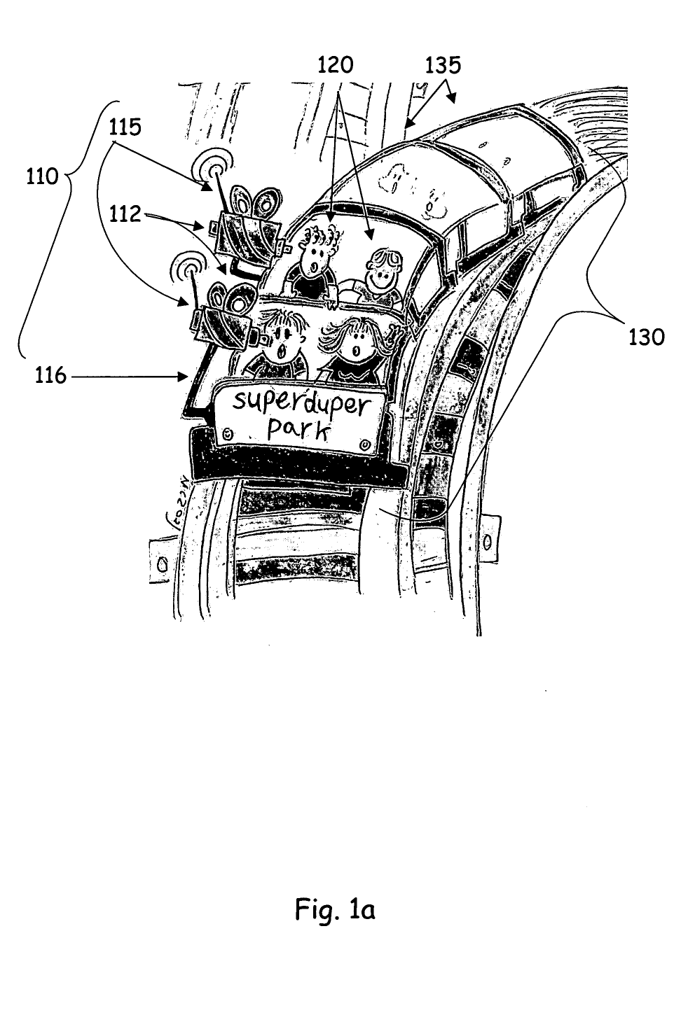

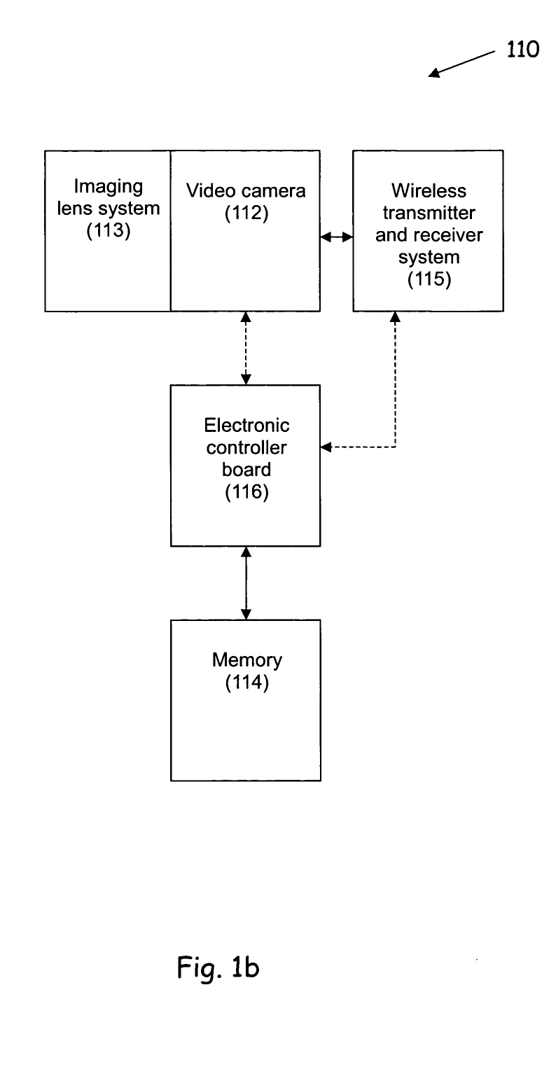

FIG. 1a is a schematic illustration, wherein each car 135 of a roller coaster train 130 is provided with a wireless video camera system 110 for recording a video movie of the people 120 during a ride, in an exemplary embodiment of the present invention. Wireless video camera system 110 consists of a video camera 112, using a charge-coupled device (CCD), complementary metal-oxide semiconductor (CMOS) or any other available video camera technology, an imaging lens system, a memory, a wireless transmitter and receiver system 115, an electronic controller board that controls all parts together and a mechanical fixture 116 that connects each camera 112 to each train car 135.

During the ride, video camera 112 takes a movie of the people 120 in car 135. Camera 112 may capture one or more persons 120 in train car 135. The video data is processed and stored in a memory embedded in camera 112, e.g. D-RAM or FLASH. When the ride is finished, roller coaster train 130 is standing in its starting point. During this time, but not limited to it, the video movies that were stored in the camera's memories are transmitted to the base unit computer through the transmitter, using wireless transmission technologies such as radio frequencies (RF), Wireless LAN (IEEE 802.11 standard), infrared (IR) optical transceiver, etc.

FIG. 1b is a schematic block diagram of the details of the wireless video camera system of FIG. 1a, according to the principles of an exemplary embodiment of the present invention. Wireless video camera system 110 consists of a video camera 112, using a charge-coupled device (CCD), complementary metal-oxide semiconductor (CMOS) or any other available video camera technology, an imaging lens system 113, a memory 114, a wireless transmitter and receiver system 115 and an electronic controller board 116 that coordinates all the parts.

A full system may include various configurations of cameras, for example one camera for each car of the roller coaster train, or any other ride apparatus, or even more than one camera per car.

In a preferred embodiment, automatic editing of the videos is provided. E.g. pre-filmed videos of the roller coaster are combined with the personal park ride portions of the videos. This is to create a much more interesting movie, that includes the people and shots from the park and from outside the roller coaster.

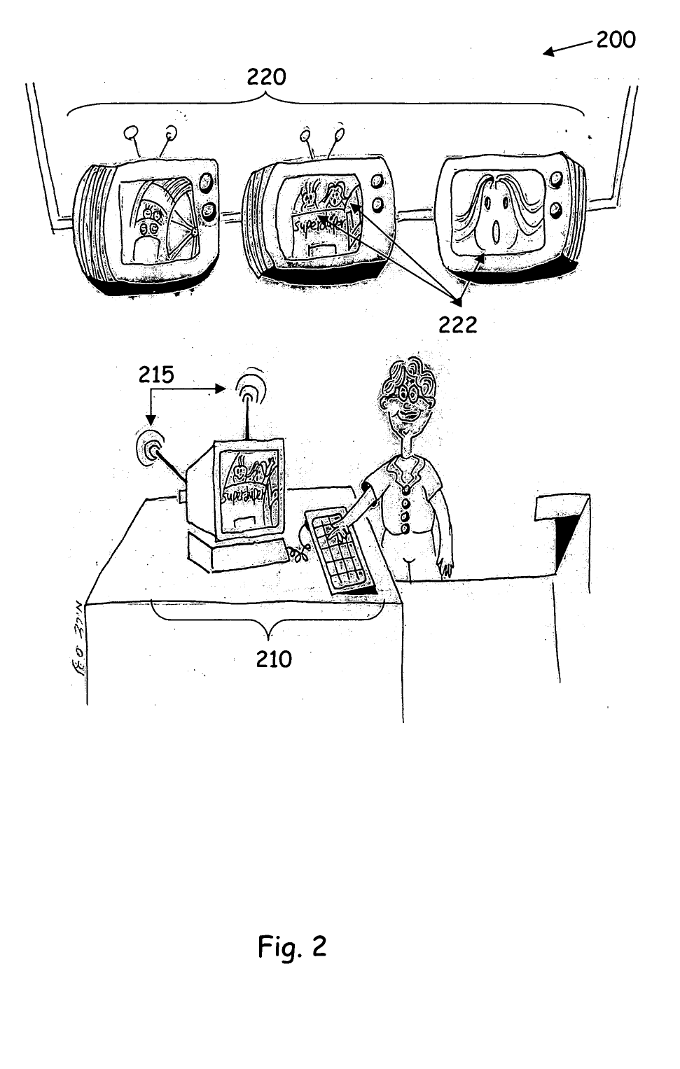

Alternatively, the video camera(s) may use real time transmission system such as analog cameras. Naturally, no digital memory is needed in the camera but the video transmission is done in real time to the base unit during the ride. Another configuration can be that the video cameras use a wired connection (rather than wireless) to transmit the data to the base unit (see FIG. 2. below).

FIG. 2 is a schematic illustration, wherein the video movie transmitted from the wireless video cameras of FIGS. 1a and 1b, is processed in the base unit 200 having receivers for the video and data from the cameras, and computers 210 to receive, process, store and record the video and data, and screens 220 to show the videos. The video movie depicting riders 222 that was transmitted from the wireless camera is received 215 and processed in the base unit computer 210 and is presented on video screens 220. People who participated in the ride can view their video movie, or a clip of a part of it, on the screens 220.

When they choose to purchase their video movie, the computer sends the video movie to a recording media such as a Digital Versatile Disc (DVD), a digital compact disc (CD) writer or an analog video tape recorder (VTR) to produce a DVD, CD or videotape cassette that contains the movie. The recording media can be any media available today or that will be developed in the future. Optionally, by means of an ATM-like machine, one can select his video, pay and get a video-CD or pay and play the video after purchasing. People can buy a CD on one ride (e.g. a roller coaster), and then go with the CD to another ride (e.g. a water-slide) and add the video of the second ride to the first CD.

A booth can be available for self-service video recording, wherein one can pay and take a video of himself (or his group altogether), smiling to the camera, then add this video to the video CD already bought in a ride or rides.

In addition, the movie can be stored in a Web server where the movie can be purchased later through the Internet or any other computer networks means.

In another embodiment of the invention, the video cameras are connected to a mobile base unit, which is located in one of the cars of the train, or any other ride apparatus. The cameras are connected through wires or are wireless (either analogically or digitally, e.g. WiFi IEEE 802.11 or 2.4 GHhz analog wireless transmission). This configuration may allow continuous transmission of the video stream from the cameras during the ride. The mobile base unit processes all videos and stores them. During the ride, or when the train finishes the ride and stops at a certain location, the mobile base unit transmits the video movies of all cars to a static base unit, which is similar to the one described above, with reference to FIG. 2.

Optionally, the wireless cameras may transmit video signals to the base unit, or mobile station as described above, in an analog format. For example, the analog wireless camera from Xoom™ Digital may be used. Using an analog wireless camera configuration may be embodied by continuous transmission of the video movies to the base unit.

In another exemplary embodiment of the present invention, the video camera can take high-resolution still pictures of the rides, instead of, or in addition to, the video movie.

In yet another preferred embodiment of the invention, a microphone or microphones are installed in the train's cars to acquire sounds and voices during the ride. The microphone(s) can be implemented inside the video camera, or in other places in the car. The audio signals can be transmitted using the same transmitter used by the camera, or an independent transmitter/receiver system, in the cars and the base unit. The audio signals are incorporated in the video movie to enrich the video movie with sounds. This use of microphones can be in addition to any other embodiment or configuration described in this document.

In another embodiment of the invention, an acceleration sensor or sensors are installed in the train's cars to acquire and record the acceleration (“g” force) applied on the car, and that has been experienced by the riders during the ride. The g force recordings will be incorporated in the movie by visual effects, e.g. by means of a gauge or graphic bars, or by any other means to enrich the video movie and the ride experience.

Other sensors can be integrated such as velocity sensor(s), light sensors, air pressure sensors and motion detectors to trigger video recording, etc. Such sensor(s) features can be used in addition to any other configuration described in this document.

In order to identify riders later for Web site use or for other purposes, tickets with identification will be given to the riders or other means of identification will be used. Optionally, additional camera(s) may be installed in the first car, or other cars to take video of the front view of the roller-coaster's path. This video shows what the rider actually sees during the ride. This video will be integrated into the personal video so the edited video will contain also front view footage to complete the presentation of images the rider experienced during the ride.

Optionally, additional cameras may be installed at other places around the ride, like on the boarding deck or along the people's queue. Video clips from these cameras can be added to the edited video of the ride.

A memory stick, or similar device, for example the Sony MSA-128A Memory Stick™ having 128 Mbytes of memory, will be dispensed to park attendees in certain locations of the park, e.g. at the entrances, and they can use it as a key to operate the cameras. Such devices can also be used to store the videos, such as the above-mentioned front view video, or for identification or any other acquired data from the sensors. The stored data can be then transferred to the base station unit by connecting the memory key to it.

As an option for a rider not to be filmed by the camera during the ride, an optional on/off button will be installed in each camera, so the rider can turn-off the camera. As another option, the mechanical housing of the camera will be designed in a way that hide the camera so the riders will not feel any inconvenienced from the existence of the camera(s). For example, a Neutral Density (ND), “dark” glass filter will cover the lens.

Illumination means, such as LED's, bulbs, etc., may be installed in the train cars in order to allow filming at low light conditions, such as nights or when the roller coaster enters into dark caves. The illumination color can be neutral (“white” light) for natural images, or can be colored to create visual effects to enhance the video imagery. The electrical power to operate the camera and all devices described hereinabove, such as sensors, illumination, etc, can be obtained from batteries that are installed in the cars, or from any other available power source, such as the car's alternator/generator.

An exemplary preferred embodiment is now described for a digital video system which is implemented on a 10 car roller coaster:

A digital video camera will be mechanically fixed on each car for a total of ten (10) cameras. Each camera is aimed to capture the people who sit in that particular car to generate a personal video of the ride. Microphones are embedded in the camera to capture sound, such as screams, of the people and the train riding noise. For example, camera Axis 2420™ with wireless LAN (IEEE 802.11) and expanded memory to 64 MB may be provided.

The digital video may be compressed using an Moving Pictures Experts Group. (MPEG) algorithm, or any other compression algorithm. Good quality streaming video preferably will use a bandwidth of 1,500 kilo-bits-per-second (Kbps). For an exemplary five (5) minute ride; the compressed video will preferably be around 64-256 Mega Bytes. The whole video movie data is stored in a Flash memory, for example, or alternatively in a tape cassette such as mini-DV™ cassette of Sony or any other storage technique. When the roller coaster gets back to its starting point, each camera transfers the video movie data that was stored in the memory to a computer that is located in a base unit. The means to transfer the data is the Wireless LAN known as IEEE 802.11a and/or 802.11b or 802.11g or any other future techniques, or any other data transmitting means, either wireless or wired. Thus, every camera has a transmitter and receiver card, e.g. D-Link DWL-AG650™.

In the base unit, a computer receives all videos from all cameras. A few TV screens, e.g., thin film transistor (TFT) 15″ flat screens, show the movies to the people who took the ride. A person who wishes to buy his movie will pay for it, or by means of any alternative arrangement in the park and the operator will use the computer to create a CD with the movie using a CD writer device, or a video home system (VHS) cassette, or a “Memory Stick” or any other popular storage mean(s)).

In case the person decided not to buy his movie at the park, he will be able to get the movie through the Internet at a Web site that stores the movies. The operation of such a Web site will be similar a to popular Internet shopping site, e.g. Amazon™ Website.

The cameras may be battery-powered or may derive power from the roller coaster's electricity or by means of solar cells.

As per the above, the present invention provides a permanent video/audio record of an entertainment experience.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

1. A system for providing a video record of a user's entertainment experience comprising:
a video camera system for continuous, close-up personal recording of the entertainment experience of the user, and transmitting said video recording to a base unit; and
a base unit for receiving, processing and distributing said video recording,
such that said video record of the user's entertainment experience becomes available to the user.

2. The system according to claim 1, wherein the video camera system uses at least one wired video camera.

3. The system according to claim 3, wherein the at least one wired video camera system uses a memory stick.

4. The system according to claim 1, wherein the video camera system uses at least one wireless video camera.

5. The system according to claim 4, wherein the video camera system comprises:
at least one video camera;
an imaging lens system; and
a wireless transmitter and receiver.

6. The system according to claim 5, wherein said imaging lens system comprises:
a lens; and
a sensor on a chip.

7. The system according to claim 5, wherein said sensor is a charge coupled device (CCD) sensor.

8. The system according to claim 5, wherein said sensor is a complementary metal-oxide semiconductor (CMOS) sensor.

9. The system according to claim 1, further comprising an electronic controller board.

10. The system according to claim 1, further comprising a memory.

11. The system according to claim 4, wherein the video camera system comprises:
at least one video camera;
an imaging pinhole system; and
a wireless transmitter and receiver.

12. The system according to claim 4, wherein the video camera system and the base are both installed on a vehicle provided for the entertainment experience, and further comprising a replay button, and wherein the user can push said replay button after the conclusion of his/her entertainment experience, in order to view the video record of his/her entertainment experience, while still onboard said vehicle.

13. A method for providing a video record of a user's entertainment experience comprising:
installing, on a vehicle provided for the entertainment experience, a video camera system comprising at least one video camera for continuous, close-up personal recording of the entertainment experience of the user;
recording a video record of the user with said video camera system during the entertainment experience; and
transmitting said video recording to a base unit for receiving, processing and distributing said video recording,
such that said video record of the user's entertainment experience becomes available to the user.

14. The method according to claim 13, further comprising automatic editing of the videos is provided.

15. The method according to claim 14, wherein the editing step comprises combing pre-filmed videos of the entertainment environment with the personal portions of the video record.

16. The method according to claim 13, further comprising, prior to said recording step, adjusting the system to record at least two users in at least one of said vehicles.
